(19) United States
(12) Patent Application Publication
(10) Pub. No.: US 2025/0054034 A1
(43) Pub. Date: Feb. 13, 2025

(54) NEGOTIATION PROTOCOL, NEGOTIATION METHOD, AND SYSTEM FOR IMPLEMENTING

(71) Applicant: NEC Corporation, Tokyo (JP)

(72) Inventor: Yasser Farouk Othman MOHAMMAD, Tokyo (JP)

(21) Appl. No.: 18/447,264

(22) Filed: Aug. 9, 2023

(51) Int. Cl. G06Q 30/0601

(52) U.S. Cl. CPC G06Q 30/0611

(57) ABSTRACT

A system for implementing a negotiation includes a non-transitory computer readable medium configured to store instructions thereon. The system further includes a processor connected to the non-transitory computer readable medium. The processor is configured to execute the instructions for preventing a party from repeating an offer during the negotiation unless a predetermined condition is satisfied. The processor is further configured to execute the instructions for requiring the party to continue to repeat the offer until an end of the negotiation in response to satisfaction of the predetermined condition.

### BACKGROUND

As commerce using the Internet has increased, autonomous negotiations have also increased. Autonomous negotiation utilizes artificial intelligence (AI) in place of human negotiators in order to attempt to reach agreements between parties. AI is used to evaluate an offer from an opponent and then determine a response to the offer. In some instances, the response is a counteroffer. In some instances, the response is acceptance of the offer. In some instances, the response is to end the negotiation.

In some approaches, an AI negotiator is fully trained with user preferences and priorities prior to beginning of a negotiation. In some approaches, an AI negotiator includes some minor uncertainty regarding user preferences and priorities at the beginning of a negotiation. In some approaches, the AI negotiator is able to submit a query to the user in order to reduce uncertainty of user preferences and priorities. However, the query merely inquiries about how valuable a specific parameter is to the user without asking a user preference between options.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a negotiation in accordance with some embodiments.

FIG. 2 is a flowchart of a negotiation protocol in accordance with some embodiments.

FIG. 3 is a flowchart of a method of determining offer validity in accordance with some embodiments.

FIG. 4 is a flowchart of a method of offer selection in accordance with some embodiments.

FIG. 5 is a view of a graphical user interface (GUI) for accompanying an automated negotiation in accordance with some embodiments.

FIG. 6 is a graph of performance of a negotiation protocol in comparison with other negotiation protocols in accordance with some embodiments.

FIG. 7 is a block diagram of a system for implementing a negotiation in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Negotiations utilizing automated systems are used in order to increase the speed of reaching a resolution between multiple self-interested parties. Each of the self-interested parties seeks to maximize the value, or utility function, of the result of the negotiation. However, some negotiation protocols incentive participants to continually repeat offers until a deadline, such as a time period for the negotiation or a maximum number of offers exchanged, for the negotiation approaches. Some negotiations waste 70%-80% of the negotiation period repeating an optimal offer that has already been rejected. Since other parties in the negotiation know of this common strategies, each of the parties in the negotiations lacks any incentive to make a lower utility offer until near the end of the negotiation. Negotiation protocols that permit repetition of offers create an incentive for each party to the negotiation to repeat a most favorable offer for that party until a risk of the negotiation failing approaches, i.e., the negotiation approaches the deadline. This incentivized repetition of offers reduces overall utility of the negotiation for both parties in some instances. That is, continually making an offer that will definitely be rejected does little to further the negotiation; and then rushing to reach an agreement near the end of the negotiation hampers the ability to explore the outcome space of the negotiation more fully to attempt to find higher utility outcomes for each of the parties in the negotiation.

In addition, some negotiation protocols terminate the negotiation when an offer is accepted. While the current application is not limited to bilateral negotiations, the following description focuses on bilateral negotiations for the sake of simplicity. In a bilateral negotiation if a first party makes an offer that is accepted by a second party, then an agreement is reached and the negotiation terminates. However, terminating a negotiation at the acceptance of an offer limits the potential to explore other offers which are also potentially acceptable to both parties. In some instances, these unexplored offers would produce an overall improvement to the utility of the negotiation to both parties. For example, the utility would improve for one of the parties without adversely impacting the other party; or the utility would improve for both parties. The failure to explore these alternative offers limits an effectiveness of the negotiation protocols that terminate immediately upon acceptance.

In contrast with other negotiation protocols, the current application includes a negotiation protocol that prevents repetition of a previous offer. By preventing repeating of an offer, the negotiation protocol forces more exploration of the outcome space for each of the parties in the negotiation in order to help increase overall utility of the negotiation outcome. Once an offer is repeated, then the same offer is maintained until an end of the negotiation. The maintaining of the same offer, once repeated, signals to the other party in the negotiation that no more alternative offers will be forthcoming. This helps to decrease uncertainty by the non-offering party and to potentially reduce a duration of the negotiation. Also, in contrast to other negotiation protocols, the current application includes a negotiation strategy that accepts all rational offers; however, the negotiation does not end merely due to acceptance of the rational offer. A rational offer includes an offer that is an acceptable outcome for a party even if the offer is not a most preferred outcome. By accepting all rational offers and continuing the negotiation after acceptance, the outcome space is more fully explored and overall utility of the negotiation is improved in comparison with other negotiation protocols.

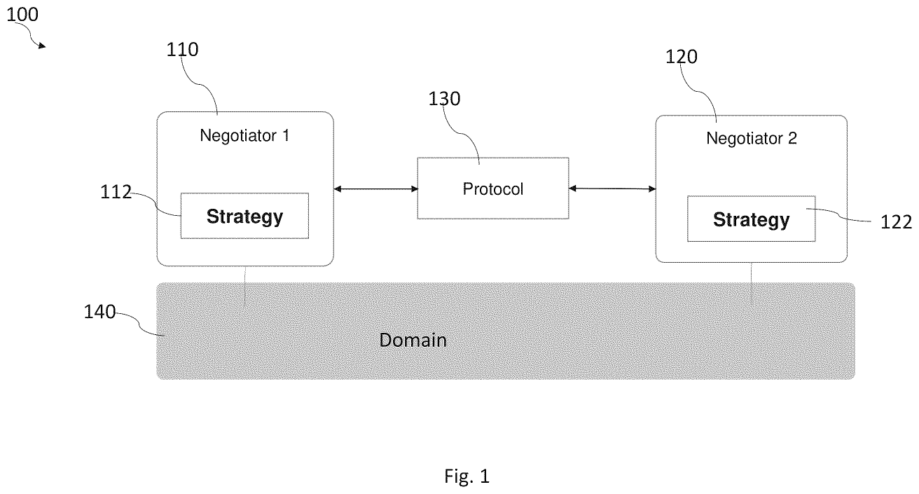

FIG. 1 is a schematic view of a negotiation 100 using an autonomous negotiation method in accordance with some embodiments. The negotiation 100 includes a first negotiator 110 including a first strategy 112. The negotiation 110 includes a second negotiator 120 including a second strategy 122. A protocol 130 is used to determine the style of negotiation between the first negotiator 110 and the second negotiator 120. A domain 140 includes the issues to be resolved in the negotiation 100. The negotiation 100 is a bilateral negotiation. However, the current disclosure is not limited to only bilateral scenarios.

The first negotiator 110 includes AI algorithms for determining priorities for the issues to be resolved. These priorities are captured in utility values associated with each of the issues to be resolved. That first negotiator 110 uses these utility values to prioritize possible outcomes from the negotiation 100. The first negotiator 110 is able to communicate with the second negotiator 120 using the protocol 130. In some embodiments, the first negotiator 110 is able to communicate wirelessly. In some embodiments, the first negotiator 110 is able to communicate using a wired connection. In some embodiments, the first negotiator 110 is able to communicate via the Internet. The first negotiator 110 is able to transmit an offer, counteroffer, acceptance or rejection to the second negotiator 120. The first negotiator 110 is autonomous, i.e., operating without user input or control.

The first strategy 112 is the action determined by the first negotiator 110 based on the utility values and algorithm used by the first negotiator 110. In some embodiments, the first strategy 112 includes an offer, a counteroffer, an acceptance or a rejection. In some embodiments, the first strategy 112 changes during the negotiation 100 based on new information received from the second negotiator 120.

The second negotiator 120 includes AI algorithms for determining priorities, captured using utility values, for the issues to be resolved. The second negotiator 120 is able to communicate with the first negotiator 110 using the protocol 130. In some embodiments, the second negotiator 120 is able to communicate wirelessly. In some embodiments, the second negotiator 120 is able to communicate using a wired connection. In some embodiments, the second negotiator 120 is able to communicate via the Internet. The second negotiator 120 is able to transmit an offer, counteroffer, acceptance or rejection to the first negotiator 110. In some embodiments, hardware for the first negotiator 110 is the same as the hardware for the second negotiator 120. In some embodiments, hardware for the first negotiator 110 is different from the hardware for the second negotiator 120. In some embodiments, the algorithms implemented in the first negotiator 110 are the same as the algorithms implemented in the second negotiator 120. In some embodiments, the algorithms implemented in the first negotiator 110 are different from algorithms implemented in the second negotiator 120. In some embodiments, the second negotiator 120 is autonomous. In some embodiments, the second negotiator 120 is controlled based on user input.

The second strategy 122 is the action determined by the second negotiator 120 based on the utility values and algorithm used by the second negotiator 120. In some embodiments, the second strategy 122 includes an offer, a counteroffer, an acceptance or a rejection. In some embodiments, the second strategy 122 changes during the negotiation 100 based on new information received from the first negotiator 110.

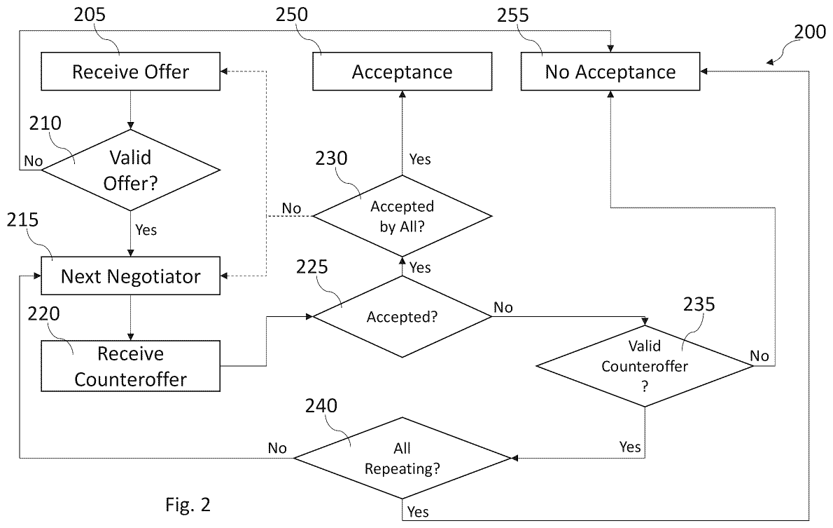

The protocol 130 is the rules for the negotiation 100. For example, in an alternating offers protocol, the negotiators, e.g., the first negotiator 110 and the second negotiator 120, exchange offers in an alternating fashion. The protocol 130 is established prior to beginning the negotiation 100 so that the first negotiator 110 and the second negotiator 120 know when and whether an offer or reply should be transmitted. In some embodiments, the negotiation protocol 130 includes a negotiation protocol 200 (FIG. 2) for determining valid offers, counteroffers, acceptance, and rejections. In some embodiments, the protocol 130 includes a maximum number of steps, e.g., offers. In some embodiments, the protocol 130 includes a time limit for the negotiation 100.

The domain 140 includes the issues to be resolved. For example, the issues to be resolved, in some embodiments, include price, quantity, brand name, etc. In some embodiments, the domain 140 includes a single issue. In some embodiments, the domain 140 includes multiple issues. Each of the first negotiator 110 and the second negotiator 120 knows the domain 140 and attributes a utility value to combinations of the issues to be resolved. For example, where the domain 140 includes price and brand name and there are two options for each of price and brand name, the first negotiator 110 will have four different utility values, i.e., one for each possible combination. In some embodiments, the first negotiator 110 and the second negotiator 120 have utility values for less than all possible combinations. In some embodiments, the utility values assigned by the first negotiator 110 are different from the utility values assigned by the second negotiator 120 because the first and second negotiators have different priorities.

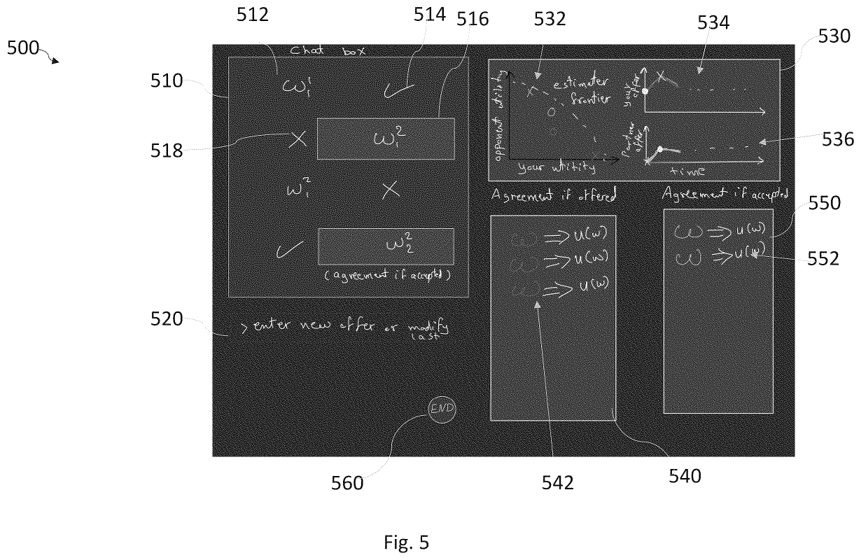

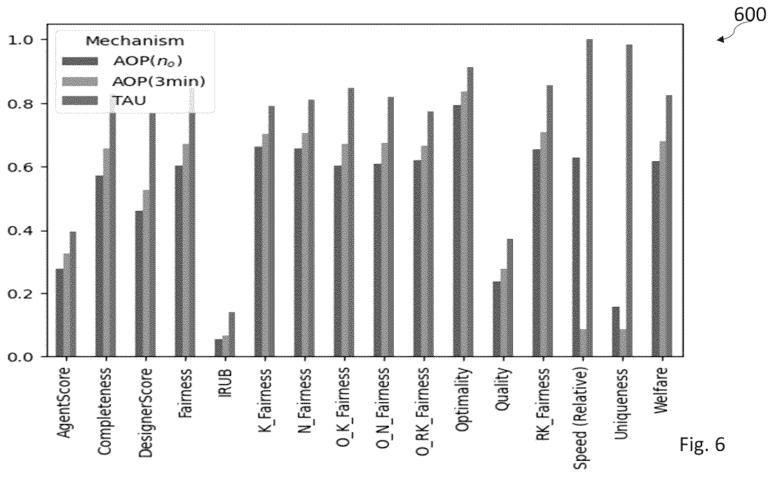

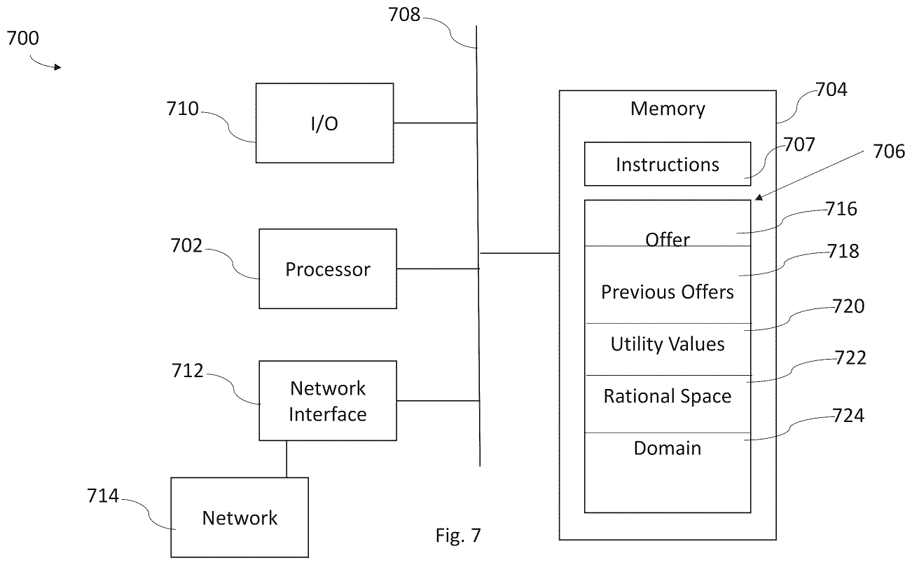

FIG. 2 is flowchart of a negotiation protocol 200 in accordance with some embodiments. In some embodiments, the negotiation protocol 200 is usable in the negotiation 100 (FIG. 1). In some embodiments, the negotiation protocol 200 is usable in a negotiation other than the negotiation 100 (FIG. 1). The negotiation protocol 200 is capable of being implemented entirely using an automated negotiation, a live human negotiation, an automated negotiation monitored by a human, or other suitable negotiations. The negotiation protocol 200 helps to explore more outcome space for the negotiation, which helps to improve utility of the negotiation outcome for all parties of the negotiation. Some performance information for the negotiation protocol 200 relative to other negotiation protocols is provided in graph 600 (FIG. 6), in accordance with some embodiments. In some embodiments, the negotiation protocol 200 is implemented using a system 700 (FIG. 7). In some embodiments, the negotiation protocol 200 is implemented using a system other than the system 700 (FIG. 7). In some embodiments, the a graphical user interface (GUI), such as GUI 500 (FIG. 5), is generated during a negotiation performed using the negotiation protocol 200. As noted above, the negotiation protocol 200 is usable for negotiations between any number of parties, but the description below focuses on bilateral negotiations for simplicity.

In operation 205, an offer is received. In some embodiments, the offer is received wirelessly. In some embodiments, the offer is received via a wired connection. In some embodiments, the offer is from an opponent (other party) in a negotiation. In some embodiments, in response to receiving the offer, a GUI, such as GUI 500 (FIG. 5), is updated. In some embodiments, a notification to a user is automatically generated in response to the receiving the offer. In some embodiments, the notification includes an audio notification or a visual notification. In some embodiments, the notification is transmitted to a wireless device accessible by the user and includes instructions for causing the wireless device to automatically announce the notification. In some embodiments including more than two parties in a negotiation, multiple offers are received simultaneously. These offers are processed either sequentially based on a predefined ordering of the offering parties; or processed simultaneously on separate machines or systems.

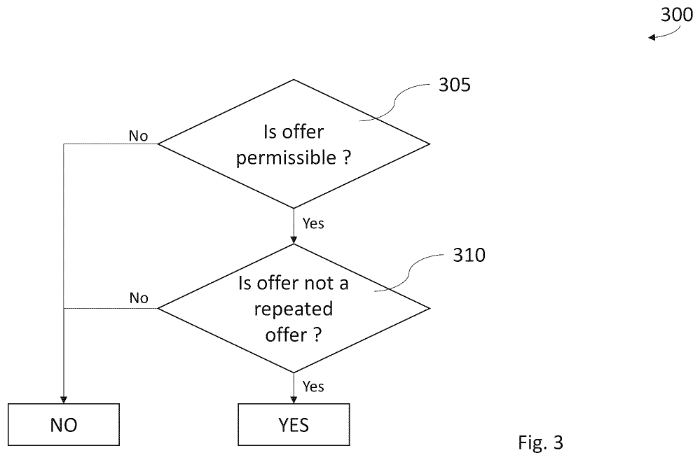

In operation 210, a determination is made regarding whether the received offer is a valid offer. A valid offer is an offer that is not a repeat of a previous offer. A repeated offer includes both an offer that matches an offer immediately preceding the current offer; as well as an offer that matches any offer from a same party during an entirety of the negotiation. In some embodiments where the domain includes multiple factors, e.g., price and quantity, a difference in any of the factors constitutes a difference in the offer. That is, the offer will be valid if the combination of factors in the offer is different from the combination of factors in all previous offers. For example, in a situation where a first offer includes a price of $10, a quantity of 100, and a delivery time of 2 weeks; and a second offer includes a price of $10, a quantity of 100, and a delivery time of 1 week, the second offer would be a valid offer. Similarly, a third offer including a price of $10, a quantity of 110, and a delivery time of 2 weeks would also constitute a valid offer. In some embodiments, a determination of whether the offer is valid is based on the method 300 (FIG. 3), described below.

In response to a determination that the offer is valid, i.e., “Yes,” the negotiation protocol 200 proceeds to operation 215. In response to a determination that the offer is invalid, i.e., “No,” the negotiation protocol 200 proceeds to operation 255.

In operation 215, a next negotiator is selected. The next negotiator selection includes determining an algorithm utilized to determine a counteroffer in response to the received offer from operation 205; and a determination of the counteroffer. In some instances, the operation 215 includes maintaining the same negotiator as that used to create at least one previous counteroffer. In some instances, during the course of a negotiation, the operation 215 will result in a change from a first negotiator to a second negotiator and later back to the first negotiator in a subsequent iteration of the negotiation using the negotiation protocol 200. In some embodiments a party includes only a single algorithm for determining counteroffers, and the operation 215 includes only determining the counteroffer. In some embodiments, a change in negotiator is determined based on a trend in utilities of previously received offers. In some embodiments, a change in negotiator is determined based on an input received from a user. In some embodiments, a change in negotiator is determined based on a remaining duration of the negotiation, e.g., time period or number of offers.

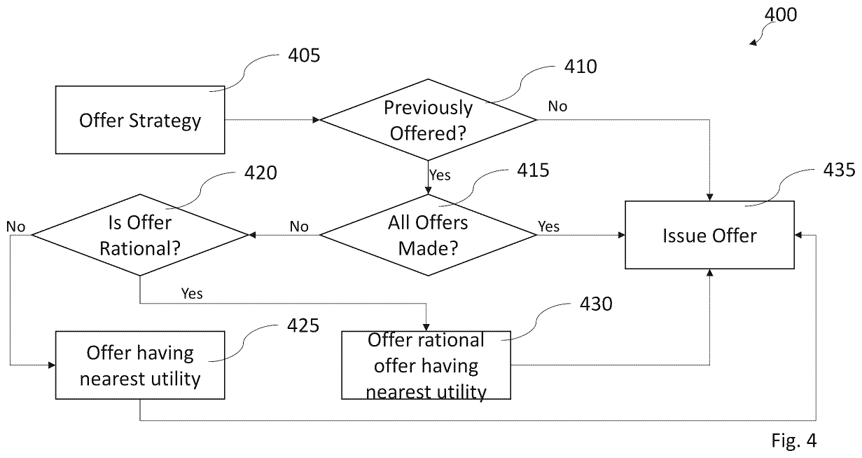

Once a determination is made regarding whether to change the negotiator, if more than one negotiator is available, the selected negotiator uses an algorithm to determine a counteroffer based on a received valid offer. In some embodiments, the counteroffer includes acceptance of the received valid offer. In some embodiments, the counteroffer includes at least one difference from the received valid offer. In some embodiments, the negotiator accepts all rational offers, i.e., if the received valid offer is a rational offer, then the counteroffer is acceptance of the received valid offer. In some embodiments, the negotiator is prevented from repeating a previous offer if other rational offers, which have not been made, are available. A rational offer is an offer that falls within an acceptable outcome space for a party of the negotiation. The acceptable outcome space is predetermined by a user in advance of the negotiation. In some embodiments, the acceptable outcome space is determined based on a utility value of the offer ranging between 0.0 and 1.0. In some embodiments, an acceptable utility value is predetermined by a user. In some embodiments, an acceptable utility value is equal to or greater than 0.2. If the utility value is lower than the acceptable utility value, then a value of failure of the negotiation to the party is greater than a value of the received offer. If no other rational offer is available, then the counteroffer is a repeat of a previous offer, such as the most recent offer from the party that received the offer in operation 205. Once the counteroffer is a repeat of a previous offer from the same party, then the counteroffer will continue repeating the same offer until the end of the negotiation. In some embodiments, an algorithm for determining the counteroffer is based on a method 400 (FIG. 4). In some embodiments, a different algorithm from method 400 (FIG. 4) is utilized to determine the counteroffer.

In operation 220, the counteroffer is received by the other party or parties to the negotiation. In some embodiments, the counteroffer is received wirelessly. In some embodiments, the counteroffer is received via a wired connection. In some embodiments, in response to receiving the counteroffer, a GUI, such as GUI 500 (FIG. 5), is updated. In some embodiments, a notification to a user is automatically generated in response to the receiving the counteroffer. In some embodiments, the notification includes an audio notification or a visual notification. In some embodiments, the notification is transmitted to a wireless device accessible by the user and includes instructions for causing the wireless device to automatically announce the notification.

In operation 225, a determination is made regarding whether the counteroffer is an acceptance. In some embodiments, the determination is made based on a comparison between values for each of the factors in the counteroffer with the values for each of the factors in the offer to determine whether the counteroffer is an acceptance. In some embodiments, the determination is made based on other information within the counteroffer that indicates acceptance.

In response to a determination that the counteroffer is acceptance, i.e., “Yes,” the negotiation protocol 200 proceeds to operation 230. In response to a determination that the counteroffer is not acceptance, i.e., “No,” the negotiation protocol 200 proceeds to operation 235.

In operation 230, a determination is made regarding whether all parties have accepted the offer. In a bilateral negotiation, an outcome of operation 225 and operation 230 will be the same. In a negotiation including more than two parties, the outcome of operation 230 and operation 225 have a potential to be different. In some embodiments, the determination is made based on a comparison between values for each of the factors in the counteroffer with the values for each of the factors in a most recent offer from each party to determine whether the counteroffer is an acceptance. In some embodiments, the determination is made based on other information within the counteroffer that indicates acceptance.

In response to a determination that the all parties have accepted, i.e., “Yes,” the negotiation protocol 200 proceeds to operation 250. In some embodiments including a bilateral negotiation, the operation 230 is omitted. In response to a determination that less than all parties have accepted, i.e., “No,” the negotiation protocol 200 proceeds to operation 205, in accordance with some embodiments. In response to a determination that less than all parties have accepted, i.e., “No,” the negotiation protocol 200 proceeds to operation 215, in accordance with some embodiments.

In operation 235, a determination is made regarding whether the counteroffer is a valid counteroffer. In some embodiments, an analysis in operation 235 is a same analysis as in operation 210. In some embodiments, an analysis in operation 235 is different from an analysis in operation 210. A valid counteroffer is a counteroffer that is not a repeat of a previous offer from the counteroffering party. A repeated counteroffer includes both a counteroffer that matches an offer immediately preceding the current counteroffer; as well as a counteroffer that matches any offer from a same party during an entirety of the negotiation. In some embodiments where the domain includes multiple factors, e.g., price and quantity, a difference in any of the factors constitutes a difference in the counteroffer. In some embodiments, a determination of whether the counteroffer is valid is based on the method 300 (FIG. 3), described below.

In response to a determination that the counteroffer is valid, i.e., “Yes,” the negotiation protocol 200 proceeds to operation 240. In response to a determination that the counteroffer is invalid, i.e., “No,” the negotiation protocol 200 proceeds to operation 255.

In operation 240, a determination is made regarding whether all parties have repeated an offer. Stated another way, a determination is made regarding whether all parties have made an invalid offer. In some embodiments, an analysis in operation 240 is a same analysis as in operation 210 or operation 235 applied to all parties. In some embodiments, an analysis in operation 240 is different from an analysis in operation 210 or operation 235 and is applied to all parties. In some embodiments, a determination of whether the all parties are repeating is based on the method 300 (FIG. 3), described below.

In response to a determination that all parties have repeated an offer, i.e., “Yes,” the negotiation protocol 200 proceeds to operation 255. In response to a determination that less than all parties have repeated an offer, i.e., “No,” the negotiation protocol 200 proceeds to operation 215.

In operation 250, acceptance of the offer received in operation 205 or the counteroffer received in operation 220, whichever is most recent, is determined. In some embodiments, in response to determining of acceptance, a GUI, such as GUI 500 (FIG. 5), is updated. In some embodiments, a notification to a user is automatically generated in response to the determining of acceptance. In some embodiments, the notification includes an audio notification or a visual notification. In some embodiments, the notification is transmitted to a wireless device accessible by the user and includes instructions for causing the wireless device to automatically announce the notification.

In operation 255, no acceptance, or failure of the negotiation, is determined. In some embodiments, in response to determining of no acceptance, a GUI, such as GUI 500 (FIG. 5), is updated. In some embodiments, a notification to a user is automatically generated in response to the determining of no acceptance. In some embodiments, the notification includes an audio notification or a visual notification. In some embodiments, the notification is transmitted to a wireless device accessible by the user and includes instructions for causing the wireless device to automatically announce the notification.

In some embodiments, the negotiation protocol 200 includes additional operations. For example, in some embodiments, the negotiation protocol 200 includes solicitation of input from a user in a user monitored negotiation. In some embodiments, at least one of the operations of the negotiation protocol 200 is omitted. For example, in some embodiments, the operation 230 is omitted in a bilateral negotiation. In some embodiments, an order of operations of the negotiation protocol 200 is modified. For example, in some embodiments, the operation 235 occurs prior to the operation 225, and a determination is made regarding the validity of the counteroffer prior to determining whether the counteroffer is acceptance.

The negotiation protocol 200 helps to explore more of an outcome space for a negotiation in comparison with other approaches. By reducing repetition of offers until a final repeated offer is made, parties are unable to “waste time” during the negotiation by repeating a highest utility offer that has been rejected until an end of the negotiation approaches. The reduced repetition of offers also removes the disincentive for other parties to likewise refuse to adjust offers until the end of the negotiation approaches. As a result, an overall utility of the negotiation is improved in comparison with other approaches. Further, once a party begins repeating offers, the other parties in the negotiation have an improved understanding of the priorities of the repeating party, which helps to reduce a length of the negotiation and save time and resources consumed by the negotiation. Evidence of improvement in overall utility and duration of the negotiation protocol 200 in comparison with other approaches is provided in the graph 600 (FIG. 6), in accordance with some embodiments.

FIG. 3 is a flowchart of a method 300 of determining offer validity in accordance with some embodiments. In some embodiments, the method 300 is usable in the negotiation 100 (FIG. 1). In some embodiments, the method 300 is usable in a negotiation other than the negotiation 100 (FIG. 1). In some embodiments, the method 300 is implemented during the negotiation protocol 200 (FIG. 2). In some embodiments, the method 300 is implemented in a negotiation protocol other than the negotiation protocol 200 (FIG. 2). In some embodiments, the method 300 is implemented using a system 700 (FIG. 7). In some embodiments, the method 300 is implemented using a system other than the system 700 (FIG. 7).

In operation 305, a determination is made regarding whether the offer is permissible. A permissible offer is an offer that includes permitted values for each of the factors in the domain. That is, the offer includes a value for each factor in the domain and each value is permitted by the parameters of the negotiation. For example, in a domain including price and quantity, an offer that includes a value for price but no value for quantity is an impermissible offer. Similarly, if parameters of the negotiation dictate that the maximum quantity is 100 units; and the offer includes a value for the price and a quantity value of 150 units, the offer is an impermissible offer. In some embodiments, the parameters of the negotiation are predetermined by the parties prior to the negotiation. In some embodiments, the parameters of the negotiation are determined based on a capability of the party to meet the value. For example, if the party is capable of a maximum production of 100 units and the offer is for 150 units, then the party is not capable of meeting the criteria of the offer and the offer is deemed impermissible.

In response to a determination that the offer is a permissible offer, i.e., “Yes,” the method 300 proceeds to operation 310. In response to a determination that the offer is an impermissible offer, i.e., “No,” the method 300 outputs an indication that the offer is not a valid offer. For example, in a situation where the method 300 is utilized in the operation 210 (FIG. 2), the determination of validity of the offer would be “No” and the negotiation protocol 200 would proceed to operation 255.

In operation 310, a determination is made regarding whether the offer is a repeated offer. As discussed above, a repeated offer is a combination of values and factors that match a previously received offer from a same party. A repeated offer includes both an offer that matches an offer immediately preceding the current offer; as well as an offer that matches any offer from a same party that does not match the last offer received from that party during an entirety of the negotiation. In some embodiments where the domain includes multiple factors, e.g., price and quantity, a difference in any of the factors constitutes a difference in the offer. That is, the offer will be valid if the combination of factors in the offer is different from the combination of factors in all previous offers.

In response to a determination that the offer is not a repeated offer, i.e., “Yes,” the method 300 outputs an indication that the offer is valid. For example, in a situation where the method 300 is utilized in the operation 210 (FIG. 2), the determination of validity of the offer would be “Yes” and the negotiation protocol 200 would proceed to operation 215. In response to a determination that the offer is a repeated offer, i.e., “No,” the method 300 outputs an indication that the offer is not a valid offer. For example, in a situation where the method 300 is utilized in the operation 210 (FIG. 2), the determination of validity of the offer would be “No” and the negotiation protocol 200 would proceed to operation 255.

In some embodiments, a determination of the method 300, i.e., valid offer or invalid offer, prompts generation of a notification. In some embodiments, the notification includes an audio notification or a visual notification. In some embodiments, the notification is transmitted to a wireless device accessible by the user and includes instructions for causing the wireless device to automatically announce the notification. In some embodiments, a GUI, such as GUI 500 (FIG. 5), is updated based on a determination of the method 300.

In some embodiments, the method 300 includes additional operations. For example, in some embodiments, the method includes generation and transmission of a notification. In some embodiments, at least one of the operations of the method 300 is omitted. For example, in some embodiments, the operation 305 is omitted and a negotiation protocol, such as negotiation protocol 200 (FIG. 2), that utilizes the method 300 would refuse to accept any impermissible offer. In some embodiments, an order of operations of the method 300 is modified. For example, in some embodiments, the operation 310 occurs prior to the operation 305.

The method 300 helps to explore more of an outcome space for a negotiation in comparison with other approaches. By reducing repetition of offers until a final repeated offer is made, parties are unable to “waste time” during the negotiation by repeating a highest utility offer that has been rejected until an end of the negotiation approaches. The reduced repetition of offers also removes the disincentive for other parties to likewise refuse to adjust offers until the end of the negotiation approaches. As a result, an overall utility of the negotiation is improved in comparison with other approaches. Further, once a party begins repeating offers, the other parties in the negotiation have an improved understanding of the priorities of the repeating party, which helps to reduce a length of the negotiation and save time and resources consumed by the negotiation. Evidence of improvement in overall utility and duration of a negotiation protocol utilizing the method 300 in comparison with other approaches is provided in the graph 600 (FIG. 6), in accordance with some embodiments.

FIG. 4 is a flowchart of a method 400 of offer selection in accordance with some embodiments. In some embodiments, the method 400 is usable in the negotiation 100 (FIG. 1). In some embodiments, the method 400 is usable in a negotiation other than the negotiation 100 (FIG. 1). In some embodiments, the method 400 is implemented during the negotiation protocol 200 (FIG. 2). In some embodiments, the method 400 is implemented in a negotiation protocol other than the negotiation protocol 200 (FIG. 2). In some embodiments, the method 400 is implemented using a system 700 (FIG. 7). In some embodiments, the method 400 is implemented using a system other than the system 700 (FIG. 7). In some embodiments, the method 400 is utilized by all parties in a negotiation. In some embodiments, the method 400 is utilized in less than all parties in the negotiation.

In operation 405, an offer strategy is generated. The offer strategy is generated using an algorithm selected the user or using a trained neural network or other machine learning method. In some embodiments, the algorithm remains constant throughout a negotiation. In some embodiments, the algorithm changes during a course of a negotiation. The offer strategy is generated based on a utility of an offer to the party in order to attempt to maximize a value of the outcome of the negotiation. In some embodiments, the offer strategy is generated in a similar manner as operation 215 (FIG. 2).

In operation 410, a determination is made regarding whether the offer was previously made. A determination of whether an offer was previously made is based on whether a value of each of the factors in the domain matches corresponding values for the factors in the domain from a preceding offer. In some embodiments, the determination regarding whether the offer was previously made is similar to the determination in the operation 210 (FIG. 2).

In response to a determination that the offer was not previously made, i.e., “No,” the method 400 proceeds to operation 435. In response to a determination that the offer was previously made, i.e., “Yes,” the method 400 proceeds to operation 415.

In operation 415, a determination is made regarding whether all possible offers have been made. That is, has every combination of values and factors in the domain been explored by previous offers during the negotiation. In some embodiments, all possible offers include both rational offers and irrational offers. That is, all possible offers include offers that have a utility value both above and below a predetermined acceptable utility value.

In response to a determination that the all offers have been made, i.e., “Yes,” the method 400 proceeds to operation 435. That is, the offer issued in operation 435 would be a repeat of a previous offer. In some embodiments where the method 400 is utilized in the negotiation protocol 200 (FIG. 2), the repeated offer issued in operation 435 will be continually repeated until an end of the negotiation. In response to a determination that less than all possible offers were made, i.e., “No,” the method 400 proceeds to operation 420.

In operation 420, a determination is made regarding the offer is rational. A rational offer is an offer having a utility value equal to or above an acceptable utility value to the party making the offer. For example, if a party sets a minimum acceptable utility value at 0.2, then any offer having a utility value equal to or greater than 0.2 would be a rational offer; and any offer having a utility value less than 0.2 would be an irrational offer.

In response to a determination that the offer was irrational, i.e., “No,” the method 400 proceeds to operation 425. In response to a determination that the offer was rational, i.e., “Yes,” the method 400 proceeds to operation 430.

In operation 425, an offer having a utility value closest to the irrational offer is selected. The negotiator executing the algorithm for offer selection adjusts the offer to be as similar as possible to the offer strategy in operation 405. The negotiator adjusts values for each of the factors in the domain until a minimum difference in utility value is determined. All previous offers are excluded from consideration during the operation 425. In operation 425, the selected offer is potentially irrational as well as potentially rational.

In operation 430, a rational offer having a utility value closest to the rational offer is selected. The negotiator executing the algorithm for offer selection adjusts the offer to be as similar as possible to the offer strategy in operation 405. The negotiator adjusts values for each of the factors in the domain until a minimum difference in utility value is determined. All previous offers are excluded from consideration during the operation 425. In operation 430, the selected offer is rational.

In operation 435, the offer is issued to the other parties in the negotiation. In some embodiments, the offer is transmitted wirelessly. In some embodiments, the offer is transmitted via a wired connection. In some embodiments, a GUI, such as GUI 500 (FIG. 5), is updated in response to issuance of the offer. In some embodiments, issuance of the offer further includes automatic generation of a notification. In some embodiments, the notification includes an audio notification or a visual notification. In some embodiments, the notification is transmitted to a device accessible by a user; and the notification includes instructions for causing the wireless device to automatically indicate the notification.

In some embodiments, the method 400 includes additional operations. For example, in some embodiments, the method 400 includes prompting of a user for approval of an offer prior to issuance. In some embodiments, at least one of the operations of the method 400 is omitted. For example, in some embodiments, the operation 420 is omitted and operations 425 and 430 are combined into a single operation for selecting an offer having a closest utility value. In some embodiments, an order of operations of the method 400 is modified. For example, in some embodiments, the operation 420 occurs prior to the operation 415.

The method 400 helps to explore more of an outcome space for a negotiation in comparison with other approaches. By reducing repetition of offers until a final repeated offer is made, parties are unable to “waste time” during the negotiation by repeating a highest utility offer that has been rejected until an end of the negotiation approaches. The reduced repetition of offers also removes the disincentive for other parties to likewise refuse to adjust offers until the end of the negotiation approaches. As a result, an overall utility of the negotiation is improved in comparison with other approaches. Further, once a party begins repeating offers, the other parties in the negotiation have an improved understanding of the priorities of the repeating party, which helps to reduce a length of the negotiation and save time and resources consumed by the negotiation. Evidence of improvement in overall utility and duration of a negotiation protocol utilizing the method 400 in comparison with other approaches is provided in the graph 600 (FIG. 6), in accordance with some embodiments.

FIG. 5 is a view of a graphical user interface (GUI) 500 for accompanying an automated negotiation in accordance with some embodiments. The GUI 500 is usable to allow a human to track an on-going negotiation. The GUI 500 is usable to allow a human to interact during an on-going negotiation. In some embodiments, the GUI 500 is usable in the negotiation 100 (FIG. 1). In some embodiments, the GUI 500 is usable in a negotiation other than the negotiation 100 (FIG. 1). In some embodiments, the GUI 500 is usable during the negotiation protocol 200 (FIG. 2). In some embodiments, the GUI 500 is usable in a negotiation protocol other than the negotiation protocol 200 (FIG. 2). In some embodiments, the GUI 500 is usable during the method 400 (FIG. 4). In some embodiments, the GUI 500 is usable in a method other than the method 400 (FIG. 4). In some embodiments, the GUI 500 is implemented using a system 700 (FIG. 7). In some embodiments, the GUI 500 is implemented using a system other than the system 700 (FIG. 7). In some embodiments, the GUI 500 is utilized by all parties in a negotiation. In some embodiments, the GUI 500 is utilized in less than all parties in the negotiation.

The GUI 500 includes a chat box 510. The chat box 510 includes each offer and counteroffer made during the negotiation along with either the offer or counteroffer was accepted or rejected. Each offer 512 in the chat box is differentiated from each counteroffer 516. In some embodiments, the offer 512 is on a first side of the chat box 510 and the counteroffer 516 is on an opposite side of the chat box 510. In some embodiment, the offer 512 is highlighted in a different color than the counteroffer 516. In some embodiments, the offer 512 is in a different font style or font color than the counteroffer 516. One of ordinary skill in the art would recognize that the above differentiations are not exhaustive and that other differentiations are within the scope of this description. The chat box 510 further includes indications of acceptance 514 and rejection 518 of a corresponding offer 512 or counteroffer 516. In some embodiments, the acceptance 514 and rejection 518 are indicated by an icon, text, or other suitable indication separate from the offer 512 and counteroffer 514. In some embodiments, the acceptance 514 and rejection 518 are indicated by alterations directly on the offer 512 or counteroffer 516, such as highlighting, bolding, underlining, or other suitable indications. In some embodiments, the chat box 510 further includes additional information such as notes associated with an offer 512 or counteroffer 516. In some embodiments, the notes include information such as “agreement if accepted,” a utility value of the offer to the user, or other suitable information.

The GUI 500 further includes an offer entry field 520 for receiving a next offer from the user. In some embodiments, the offer entry field 520 is automatically populated when the GUI 500 is being controlled during an automated negotiation. In some embodiments, the offer entry field 520 is configured to receive input from the user when human interaction is permitted during the negotiation. In some embodiments, the user enters a command or makes an action to switch between fully automated negotiation and a negotiation allowing human interaction. In some embodiments, the offer entry field 520 is only editable by the user during a negotiation that permits human interaction. In some embodiments, the offer entry field 520 is configured to generate a notification, such as an audio notification or a visual notification in response to an offer in the offer entry field 520 being a repeat offer. In some embodiments, the GUI 500 is configured to prompt the user for confirmation of issuance of a repeat offer prior to issuing the repeat offer in response to receiving confirmation from the user.

The GUI 500 further includes a trend field 530. The trend field 530 includes information to allow the user to determine how the negotiation has progressed over time. In some embodiments, the trend field 530 includes one or more graphs. In some embodiments, graphs displayed in the trend field 530 are selectable by the user.

The trend field 530 in FIG. 5 includes a first graph 532 indicating a utility value to the user for each offer and counteroffer as well as a projected utility value to another party for each offer and counteroffer. In some embodiments, the projected utility value is based on empirical data from previous negotiations; analysis of offers received from the other party during the negotiation; or other suitable information. In some embodiments, the projected utility value is determined using a trained neural network. In some embodiments, the first graph 532 further includes an estimated frontier plot. The estimated frontier plot indicates a projected acceptable outcome space for both parties in the negotiation. That is, the acceptable outcome space would be the area underneath the estimated frontier plot. In some embodiments, the estimated frontier plot is based on empirical data from previous negotiations; analysis of offers received from the other party during the negotiation; or other suitable information. In some embodiments, the estimated frontier plot is determined using a trained neural network.

The trend field 530 in FIG. 5 includes a second graph 534 indicating a utility value of each offer made by the user during the negotiation. The second graph 534 includes a plot of a utility value versus time; however, in some embodiments, the plot includes utility value versus negotiation round. In some embodiments, the second graph 534 further includes an acceptable utility value for the user. That is, any utility value above the acceptable utility value would have more value to the user than a failure to reach agreement during the negotiation. In some embodiments, the second graph 534 further includes an estimated acceptable utility value for the other party. That is, any utility value above the estimated acceptable utility value for the other party is predicted to have higher value to the other party than failure of the negotiation. In some embodiments, the estimated acceptable utility value for the other party is based on empirical data from previous negotiations; analysis of offers received from the other party during the negotiation; or other suitable information. In some embodiments, the estimated acceptable utility value for the other party is determined using a trained neural network.

The trend field 530 in FIG. 5 includes a third graph 536 indicating a utility value of each counteroffer made by the other party during the negotiation. The third graph 536 includes a plot of a utility value versus time; however, in some embodiments, the plot includes utility value versus negotiation round. In some embodiments, the third graph 536 further includes an acceptable utility value for the user. That is, any utility value above the acceptable utility value would have more value to the user than a failure to reach agreement during the negotiation. In some embodiments, the third graph 536 further includes an estimated acceptable utility value for the other party. That is, any utility value above the estimated acceptable utility value for the other party is predicted to have higher value to the other party than failure of the negotiation. In some embodiments, the estimated acceptable utility value for the other party is based on empirical data from previous negotiations; analysis of offers received from the other party during the negotiation; or other suitable information. In some embodiments, the estimated acceptable utility value for the other party is determined using a trained neural network.

One of ordinary skill in the art would understand that the specific graphs mentioned for the trend field 530 are only exemplary and that other graphs are within the scope of this description.

The GUI 500 further includes a first list 540. The first list 540 includes a list of potential offers that are projected to be accepted by the other party if offered by the user. The first list 540 provides a tool for the user to review potential offers for entering into the offer entry field 520. The first list 540 includes multiple entries 542. Each entry 542 includes an offer and a utility value of the corresponding offer. In some embodiments, an entry 542 is removed from the first list 540 in response to the entry 542 being offered to the other party in the negotiation. In some embodiments, the first list 540 is populated using a trained neural network based on an acceptable utility value for the user as well as analysis of the current and/or previous negotiations with the other party. In some embodiments, the user is able to automatically populate the offer entry field 520 by selecting an entry 542 in the first list 540.

The GUI 500 further includes a second list 550. The second list 550 includes a list of potential counteroffers that are acceptable by the user. The second list 550 provides a tool for the user to preview potential counteroffers and/or for entering into the offer entry field 520. The second list 550 includes multiple entries 552. Each entry 552 includes an offer and a utility value of the corresponding offer. In some embodiments, an entry 552 is removed from the second list 550 in response to the entry 552 being offered by the other party in the negotiation. In some embodiments, the second list 550 is populated using a trained neural network based on an acceptable utility value for the user as well as analysis of the current and/or previous negotiations with the other party. In some embodiments, the user is able to automatically populate the offer entry field 520 by selecting an entry 552 in the second list 550.

The GUI 500 provides a useful tool for the user to monitor an automated negotiation as well as a guide for interacting with a negotiation that permits human interaction. By tracking the offers, counteroffers, and projecting utility values for the other party, the GUI 500 allows that user to determine which portions of the outcome space have not been explored and to identify potential offers for shortening the negotiation.

FIG. 6 is a graph 600 of performance of a negotiation protocol in comparison with other negotiation protocols in accordance with some embodiments. The graph 600 includes a bar graph that compares a negotiation protocol as described in the current application, such as negotiation protocol 200 (FIG. 2), with other negotiation protocols. The graph 600 includes a variety of metrics for evaluation of the performance of the negotiation protocols. The metrics are known to those of ordinary skill in the art and only a few of the metrics are discussed in this application for the sake of brevity.

The graph 600 compares a negotiation protocol for this application (TAU), against an alternating offer protocol (AOP) having a three minute (3 min) negotiation duration, and against an AOP having a preset number of rounds (nₒ) of negotiation. The TAU performance is a right-most bar for each metric; the AOP (3 min) is a middle bar for each metric; and the AOP (nₒ) is a left-most bar for each metric. The graph 600 was generated by performing automated negotiations utilizing each of the three protocols for domains from the Automated Negotiating Agents Competition (ANAC) from each of the years of 2010 to 2016 and 2019.

The graph 600 indicates a higher value in every metric. While a higher value is desired in most metrics, the information revelation (IRUB) metric often is desired to be smaller. IRUB is a measure of how much information another party in a negotiation is able to obtain about the utility values for the user. Often users seek to reduce knowledge of internal valuation by other parties. However, as clearly indicated by metrics such as Optimality, Welfare, and Speed, the TAU protocol significantly outperforms the other protocols in actual outcome. Optimality is a measure of how different the outcome of the negotiation is from the Parento-frontier. Welfare is a measure of a total the utility values for each of the parties in the negotiation. Speed is a measure of how quickly the negotiation is resolved. The graph 600 provides clear evidence that the TAU protocol, such as negotiation protocol 200 (FIG. 2), provides an improvement in the technical field of automated negotiation in comparison with other approaches.

FIG. 7 is a block diagram of a system 700 for implementing a negotiation in accordance with some embodiments. System 700 includes a hardware processor 702 and a non-transitory, computer readable storage medium 704 encoded with, i.e., storing, the computer program code 706, i.e., a set of executable instructions. Computer readable storage medium 704 is also encoded with instructions 707 for interfacing with external devices, such as devices accessible by a user. The processor 702 is electrically coupled to the computer readable storage medium 704 via a bus 708. The processor 702 is also electrically coupled to an input/output (I/O) interface 710 by bus 708. A network interface 712 is also electrically connected to the processor 702 via bus 708. Network interface 712 is connected to a network 714, so that processor 702 and computer readable storage medium 704 are capable of connecting to external elements via network 714. The processor 702 is configured to execute the computer program code 706 encoded in the computer readable storage medium 704 in order to cause system 700 to be usable for performing a portion or all of the operations as described in negotiation protocol 200 (FIG. 2), the method 300 (FIG. 3), the method 400 (FIG. 4), or the GUI 500 (FIG. 5).

In some embodiments, the processor 702 is a central processing unit (CPU), a multi-processor, a distributed processing system, an application specific integrated circuit (ASIC), and/or a suitable processing unit.

In some embodiments, the computer readable storage medium 704 is an electronic, magnetic, optical, electromagnetic, infrared, and/or a semiconductor system (or apparatus or device). For example, the computer readable storage medium 704 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 704 includes a compact disk-read only memory (CD-ROM), a compact disk-read/write (CD-R/W), and/or a digital video disc (DVD).

In some embodiments, the storage medium 704 stores the computer program code 706 configured to cause system 700 to perform a portion or all of the operations as described in negotiation protocol 200 (FIG. 2), the method 300 (FIG. 3), the method 400 (FIG. 4), or the GUI 500 (FIG. 5). In some embodiments, the storage medium 704 also stores information for performing a portion or all of the operations as described in negotiation protocol 200 (FIG. 2), the method 300 (FIG. 3), the method 400 (FIG. 4), or the GUI 500 (FIG. 5) as well as information generated during performing a portion or all of the operations as described in negotiation protocol 200 (FIG. 2), the method 300 (FIG. 3), the method 400 (FIG. 4), or the GUI 500 (FIG. 5), such as an offer parameter 716, a previous offer parameter 718, a utility value parameter 720, a rational space parameter 722, a domain parameter 724 and/or a set of executable instructions to perform the operation of a portion or all of the operations as described in negotiation protocol 200 (FIG. 2), the method 300 (FIG. 3), the method 400 (FIG. 4), or the GUI 500 (FIG. 5).

In some embodiments, the storage medium 704 stores instructions 707 for interfacing with external components. The instructions 707 enable processor 702 to generate instructions readable by the external components to effectively implement a portion or all of the operations as described in negotiation protocol 200 (FIG. 2), the method 300 (FIG. 3), the method 400 (FIG. 4), or the GUI 500 (FIG. 5).

System 700 includes I/O interface 710. I/O interface 710 is coupled to external circuitry. In some embodiments, I/O interface 710 includes a keyboard, keypad, mouse, trackball, trackpad, and/or cursor direction keys for communicating information and commands to processor 702.

System 700 also includes network interface 712 coupled to the processor 702. Network interface 712 allows system 700 to communicate with network 714, to which one or more other computer systems are connected. Network interface 712 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in negotiation protocol 200 (FIG. 2), the method 300 (FIG. 3), the method 400 (FIG. 4), or the GUI 500 (FIG. 5) is implemented in two or more systems 700, and information is exchanged between different systems 700 via network 714.

### Supplemental Note 1

A system for implementing a negotiation includes a non-transitory computer readable medium configured to store instructions thereon. The system further includes a processor connected to the non-transitory computer readable medium. The processor is configured to execute the instructions for preventing a party from repeating an offer during the negotiation unless a predetermined condition is satisfied. The processor is further configured to execute the instructions for requiring the party to continue to repeat the offer until an end of the negotiation in response to satisfaction of the predetermined condition.

### Supplemental Note 2

The system of Supplemental Note 1, wherein the predetermined condition includes all acceptable offers for the party have been issued.

### Supplemental Note 3

The system of Supplemental Note 1, wherein the processor is further configured to execute the instructions for receiving the offer; determining whether the offer is valid; and generating a response to the offer in response to a determination that the offer is valid.

### Supplemental Note 4

The system of Supplemental Note 3, wherein the processor is further configured to execute the instructions for determining whether the offer is valid based on whether the offer matches a previous offer from the party during the negotiation.

### Supplemental Note 5

The system of Supplemental Note 3, wherein the processor is configured to execute the instructions for generating the response to the offer including acceptance in response to the offer being a rational offer; and generating the response to the offer including a counteroffer in response to the offer being an irrational offer.

### Supplemental Note 6

The system of Supplemental Note 1, wherein the processor is further configured to execute the instructions for determining whether all parties in the negotiation accept the offer; and generating a second offer different from the offer in response to a determination that less than all parties in the negotiation accept the offer.

### Supplemental Note 7

The system of Supplemental Note 1, wherein the processor is further configured to execute the instructions for determining whether all parties in the negotiation have issued repeat offers; and terminating the negotiation without acceptance in response to a determination that all parties in the negotiation have issued repeat offers.

### Supplemental Note 8

A method of implementing a negotiation includes preventing a party from repeating an offer during the negotiation unless a predetermined condition is satisfied. The method further includes requiring the party to continue to repeat the offer until an end of the negotiation in response to satisfaction of the predetermined condition.

### Supplemental Note 9

The method of Supplemental Note 8, wherein the predetermined condition includes all acceptable offers for the party have been issued.

### Supplemental Note 10

The method of Supplemental Note 8, further including receiving the offer; determining whether the offer is valid; and generating a response to the offer in response to a determination that the offer is valid.

### Supplemental Note 11

The method of Supplemental Note 10, wherein determining whether the offer is valid based on whether the offer matches a previous offer from the party during the negotiation.

### Supplemental Note 12

The method of Supplemental Note 10, further including generating the response to the offer including acceptance in response to the offer being a rational offer; and generating the response to the offer including a counteroffer in response to the offer being an irrational offer.

### Supplemental Note 13

The method of Supplemental Note 8, further including determining whether all parties in the negotiation accept the offer; and generating a second offer different from the offer in response to a determination that less than all parties in the negotiation accept the offer.

### Supplemental Note 14

The method of Supplemental Note 8, further including determining whether all parties in the negotiation have issued repeat offers; and terminating the negotiation without acceptance in response to a determination that all parties in the negotiation have issued repeat offers.

### Supplemental Note 15

A non-transitory computer readable medium configured to store instructions for causing a processor to implement a negotiation. The instructions are configured to cause the processor to prevent a party from repeating an offer during the negotiation unless a predetermined condition is satisfied. The instructions are further configured to cause the processor to require the party to continue to repeat the offer until an end of the negotiation in response to satisfaction of the predetermined condition.

### Supplemental Note 16

The non-transitory computer readable medium of Supplemental Note 15, wherein the predetermined condition includes all acceptable offers for the party have been issued.

### Supplemental Note 17

The non-transitory computer readable medium of Supplemental Note 15, wherein the instructions are further configured to cause the processor to receive the offer; determine whether the offer is valid; and generate a response to the offer in response to a determination that the offer is valid.

### Supplemental Note 18

The non-transitory computer readable medium of Supplemental Note 17, wherein the instructions are further configured to cause the processor to determine whether the offer is valid based on whether the offer matches a previous offer from the party during the negotiation.

### Supplemental Note 19

The non-transitory computer readable medium of Supplemental Note 17, wherein the instructions are further configured to cause the processor to generate the response to the offer including acceptance in response to the offer being a rational offer; and generate the response to the offer including a counteroffer in response to the offer being an irrational offer.

### Supplemental Note 20

The non-transitory computer readable medium of Supplemental Note 15, wherein the instructions are further configured to cause the processor to determine whether all parties in the negotiation accept the offer; and generate a second offer different from the offer in response to a determination that less than all parties in the negotiation accept the offer.

### Supplemental Note 21

A system for implementing a negotiation includes a non-transitory computer readable medium configured to store instructions thereon. The system further includes a processor connected to the non-transitory computer readable medium. The processor is configured to execute the instructions for generating an offer strategy using an algorithm. The processor is further configured to execute the instructions for determining whether the generated offer strategy was previously offered during the negotiation. The processor further configured to execute the instructions for issuing the generated offer strategy in response to a determination that the offer was not previously offered during the negotiation. The processor further configured to execute the instructions for changing the generated offer strategy to a second offer strategy based on a utility value of the second offer strategy in response to a determination that the offer was previously offered during the negotiation. The processor is further configured to execute the instructions for issuing the second offer strategy following the changing of the generated offer strategy.

### Supplemental Note 22

A system for implementing a negotiation includes a non-transitory computer readable medium configured to store instructions thereon. The system further includes a processor connected to the non-transitory computer readable medium. The processor is configured to execute the instructions for receiving an offer. The processor is further configured to execute the instructions for determining whether to accept the offer. The processor is further configured to execute the instructions for generating a counteroffer. The processor further configured to execute the instructions for receiving a response to the counteroffer. The processor further configured to execute the instructions for updating a graphical user interface (GUI) following receipt of the response to include: the offer, the determination whether to accept the offer, the counteroffer, the response to the counteroffer, and a list of offers projected to be acceptable to an opposing party in the negotiation.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for implementing a negotiation comprising:
a non-transitory computer readable medium configured to store instructions thereon; and
a processor connected to the non-transitory computer readable medium, wherein the processor is configured to execute the instructions for:
preventing a party from repeating an offer during the negotiation unless a predetermined condition is satisfied; and
requiring the party to continue to repeat the offer until an end of the negotiation in response to satisfaction of the predetermined condition.

2. The system of claim 1, wherein the predetermined condition includes all acceptable offers for the party have been issued.

3. The system of claim 1, wherein the processor is further configured to execute the instructions for:
receiving the offer;
determining whether the offer is valid; and
generating a response to the offer in response to a determination that the offer is valid.

4. The system of claim 3, wherein the processor is further configured to execute the instructions for determining whether the offer is valid based on whether the offer matches a previous offer from the party during the negotiation.

5. The system of claim 3, wherein the processor is configured to execute the instructions for:
generating the response to the offer including acceptance in response to the offer being a rational offer; and
generating the response to the offer including a counteroffer in response to the offer being an irrational offer.

6. The system of claim 1, wherein the processor is further configured to execute the instructions for:
determining whether all parties in the negotiation accept the offer; and
generating a second offer different from the offer in response to a determination that less than all parties in the negotiation accept the offer.

7. The system of claim 1, wherein the processor is further configured to execute the instructions for:
determining whether all parties in the negotiation have issued repeat offers; and
terminating the negotiation without acceptance in response to a determination that all parties in the negotiation have issued repeat offers.

8. A method of implementing a negotiation comprising:
preventing a party from repeating an offer during the negotiation unless a predetermined condition is satisfied; and
requiring the party to continue to repeat the offer until an end of the negotiation in response to satisfaction of the predetermined condition.

9. The method of claim 8, wherein the predetermined condition includes all acceptable offers for the party have been issued.

10. The method of claim 8, further comprising:
receiving the offer;
determining whether the offer is valid; and
generating a response to the offer in response to a determination that the offer is valid.

11. The method of claim 10, wherein determining whether the offer is valid based on whether the offer matches a previous offer from the party during the negotiation.

12. The method of claim 10, further comprising:
generating the response to the offer including acceptance in response to the offer being a rational offer; and
generating the response to the offer including a counteroffer in response to the offer being an irrational offer.

13. The method of claim 8, further comprising:
determining whether all parties in the negotiation accept the offer; and
generating a second offer different from the offer in response to a determination that less than all parties in the negotiation accept the offer.

14. The method of claim 8, further comprising:
determining whether all parties in the negotiation have issued repeat offers; and
terminating the negotiation without acceptance in response to a determination that all parties in the negotiation have issued repeat offers.

15. A non-transitory computer readable medium configured to store instructions for causing a processor to implement a negotiation, wherein the instructions are configured to cause the processor to:
prevent a party from repeating an offer during the negotiation unless a predetermined condition is satisfied; and
require the party to continue to repeat the offer until an end of the negotiation in response to satisfaction of the predetermined condition.

16. The non-transitory computer readable medium of claim 15, wherein the predetermined condition includes all acceptable offers for the party have been issued.

17. The non-transitory computer readable medium of claim 15, wherein the instructions are further configured to cause the processor to:
receive the offer;
determine whether the offer is valid; and
generate a response to the offer in response to a determination that the offer is valid.

18. The non-transitory computer readable medium of claim 17, wherein the instructions are further configured to cause the processor to determine whether the offer is valid based on whether the offer matches a previous offer from the party during the negotiation.

19. The non-transitory computer readable medium of claim 17, wherein the instructions are further configured to cause the processor to:
generate the response to the offer including acceptance in response to the offer being a rational offer; and
generate the response to the offer including a counteroffer in response to the offer being an irrational offer.

20. The non-transitory computer readable medium of claim 15, wherein the instructions are further configured to cause the processor to:
determine whether all parties in the negotiation accept the offer; and
generate a second offer different from the offer in response to a determination that less than all parties in the negotiation accept the offer.
